(19) United States
(12) Patent Application Publication
(10) Pub. No.: US 2026/0220583 A1
(43) Pub. Date: Jul. 30, 2026

(54) SKILL ANALYSIS SYSTEM AND SKILL ANALYSIS METHOD

(71) Applicant: HITACHI, LTD., Tokyo (JP)

(72) Inventors: Hiroshi SHIRATORI, Tokyo (JP); Isamu TAKAHASHI, Tokyo (JP); Makoto OGATA, Tokyo (JP); Kazutoshi SUGIE, Tokyo (JP)

(21) Appl. No.: 19/149,940

(22) PCT Filed: Jan. 10, 2024
(86) PCT No.: PCT/JP2024/000245

§ 371 Date: Jul. 22, 2025

(30) Foreign Application Priority Data
May 31, 2023 (JP) 2023-090013

(51) Int. Cl. G06Q 10/0639; G06F 17/18

(52) U.S. Cl. CPC G06Q 10/06395; G06F 17/18

(57) ABSTRACT

Provided is a skill analysis system and the like that improve precision of analysis. A skill analysis system includes: a processing unit that performs regression analysis using a feature of measurement data regarding work performed by a worker on a work object as a predictor variable and using quality data of the work object as a response variable, and causes a display unit to display an extraction result of an important feature based on the regression analysis, in which the processing unit excludes, from an object of the regression analysis, an outlier that is on a low quality side in the quality data and the measurement data that corresponds to the quality data of the outlier.

### TECHNICAL FIELD

The present disclosure relates to a skill analysis system and the like.

### BACKGROUND ART

As a technique for extracting a feature that affects a predetermined quality of a work object, for example, a technique described in PTL 1 is known. That is, PTL 1 describes that “among representative features, a representative feature that contributes to variation in the product quality data is determined as a quality influencing factor candidate”.

### CITATION LIST

### Patent Literature

PTL 1: JP2021-192137A

### SUMMARY OF INVENTION

### Technical Problem

According to the technique described in PTL 1, features that are likely to affect the quality of a product (work object) are extracted, but there is room for improvement in terms of precision of analysis.

Therefore, an object of the present disclosure is to provide a skill analysis system and the like that improve the precision of analysis.

### Solution to Problem

To solve the above problem, a skill analysis system according to the present disclosure includes a processing unit that performs regression analysis using a feature of measurement data regarding work performed by a worker on a work object as a predictor variable and using quality data of the work object as a response variable, and causes a display device to display an extraction result of an important feature based on the regression analysis, in which the processing unit excludes, from an object of the regression analysis, an outlier that is on a low quality side in the quality data and the measurement data that corresponds to the quality data of the outlier.

### Advantageous Effects of Invention

According to the present disclosure, a skill analysis system and the like that improve precision of analysis can be provided.

### BRIEF DESCRIPTION OF DRAWINGS

FIG. 1 is a diagram illustrating an example of a unit to be analyzed in a skill analysis system according to a first embodiment.

FIG. 2 is a functional block diagram of the skill analysis system according to the first embodiment.

FIG. 3 is a flowchart of processing executed by a processing unit of the skill analysis system according to the first embodiment.

FIG. 4 is a box-and-whisker plot for excluding quality data of a lower outlier in the skill analysis system according to the first embodiment.

FIG. 5 is a display example relating to threshold setting for the lower outlier in the skill analysis system according to the first embodiment.

FIG. 6 is a diagram regarding correlation data of the skill analysis system according to the first embodiment.

FIG. 7 is a diagram regarding multiple regression analysis, which is an example of regression analysis in the skill analysis system according to the first embodiment.

FIG. 8 is a display example of an analysis result of the skill analysis system according to the first embodiment.

FIG. 9 is a flowchart of processing executed by a processing unit of a skill analysis system according to a second embodiment.

FIG. 10 is a diagram regarding selection of a feature as an object of the regression analysis in the skill analysis system according to the second embodiment.

FIG. 11 is a functional block diagram of a skill analysis system according to a third embodiment.

FIG. 12 is a flowchart of processing executed by a processing unit of the skill analysis system according to the third embodiment.

FIG. 13 is a display example of a selection screen for a model used in regression analysis in the skill analysis system according to the third embodiment.

FIG. 14 is a diagram regarding extraction of an important feature when a plurality of types of models are used in the skill analysis system according to the third embodiment.

### DESCRIPTION OF EMBODIMENTS

### First Embodiment

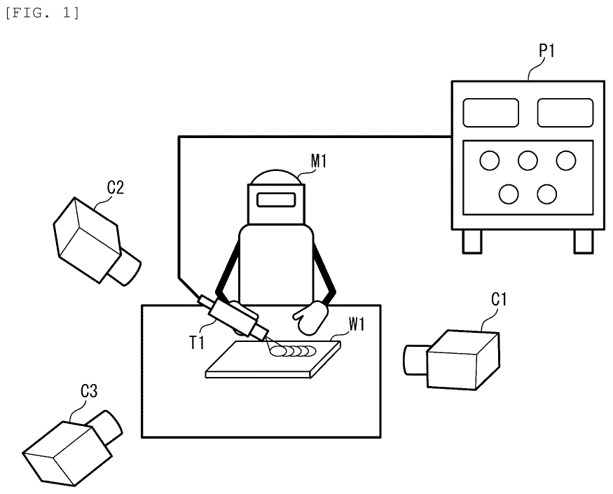

In the following, as an example, a case will be described in which analysis is performed based on quality data and measurement data regarding welding work of a worker M1 (see FIG. 1), but a type of work to be analyzed is not limited to welding. For example, in addition to painting and casting, it is possible to analyze a variety of types of work such as forging, cutting, grinding, precision machining, plating, sheet metal processing, mold finishing, and lens polishing.

FIG. 1 is a diagram illustrating an example of a unit to be analyzed in a skill analysis system according to the first embodiment.

FIG. 1 illustrates a state in which the worker M1 performs welding on a work object W1. The worker M1 uses a welding torch T1 connected to a welding power source P1 to perform arc welding with a tip of a welding wire (not illustrated) brought close to the work object W1. Note that the welding wire is fed from a wire feeding device (not illustrated). The state in which the worker M1 performs the welding is imaged by cameras C1, C2, and C3 for operation measurement. Values of a voltage and a current of the welding power source P1 are detected from moment to moment. Note that imaging results of the cameras C1, C2, and C3 and detected values of the voltage and the current are used as measurement data regarding the welding work.

After the worker M1 performs a series of work, another worker (not illustrated) performs the same work, and predetermined measurement data regarding the work is obtained. The number of workers performing the predetermined work to be analyzed may be, for example, several tens of workers, or several hundreds or several thousands of workers. The workers may include skilled workers, semiskilled workers, and unskilled workers. In this way, it is easy to identify in what aspects the skilled workers excel as compared with other workers. Since data of various workers with different skill levels can be obtained, precision of regression analysis described below can be improved.

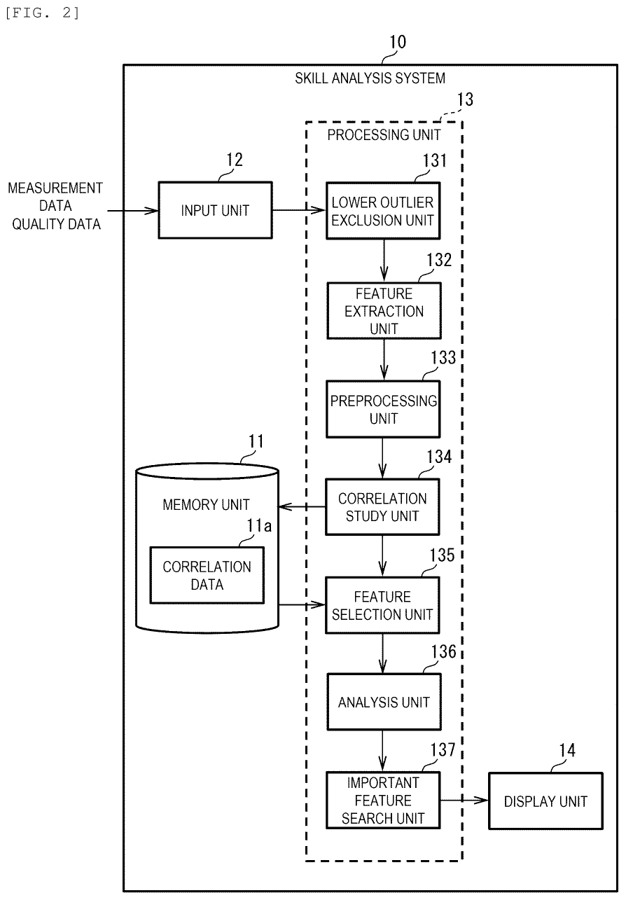

FIG. 2 is a functional block diagram of a skill analysis system 10.

The skill analysis system 10 is a system that analyzes work performed by a worker on a predetermined work object, extracts an important feature, and presents the important feature to a user. Such a skill analysis system 10 may be implemented by a single computer (for example, a server), or may be implemented by a plurality of computers (not illustrated) connected in a predetermined manner via signal lines or a network.

As illustrated in FIG. 2, the skill analysis system 10 includes a memory unit 11, an input unit 12, a processing unit 13, and a display unit 14 (display device). Although not illustrated, the memory unit 11 includes a non-volatile memory such as a read only memory (ROM), and a volatile memory such as a random access memory (RAM) or a register. The memory unit 11 stores a predetermined program in advance, as well as correlation data 11a, which will be described below. In addition, measurement data and quality data input via the input unit 12 and a calculation result of the processing unit 13 are also stored in the memory unit 11.

The input unit 12 is an interface used for inputting predetermined measurement data and quality data. For example, measurement data and quality data are input via the input unit 12 from a predetermined database (not illustrated).

Note that the “measurement data” refers to predetermined data obtained by measuring operation of the worker from moment to moment. For example, when welding work is analyzed, the measurement data used includes a tilt angle and a welding speed of the welding torch T1 (see FIG. 1), a target position of the welding, a feeding amount of the welding wire (not illustrated) per unit time, and values of the voltage and the current of the welding power source P1 (see FIG. 1). The measurement data used may also include operation data of the worker obtained by motion capture (not illustrated) and values of a temperature and a pressure of the work object. In addition to a line of sight and a posture of the worker, biometric data such as breathing, heartbeat, and brain waves of the worker can also be used as the measurement data.

The “quality data” refers to data that indicates quality of the work object. Such quality data includes, for example, the number of defects in the work object, an amount of deviation from a predetermined target value, a disorder degree in weld beads, and a predetermined scoring result. The quality data is associated with the above-mentioned plurality of types of measurement data. A set of measurement data and quality data is input via the input unit 12. For example, the operation data and the measurement data such as a current value obtained during the welding work for one time and the number of defects (quality data) in the work object after this welding work may be input as a set. Note that precision of analysis tends to become higher as an amount of the measurement data and the quality data becomes larger.

The processing unit 13 illustrated in FIG. 2 is, for example, a central processing unit (CPU), and reads out a program stored in the memory unit 11 and executes predetermined processing. The display unit 14 displays a processing result of the processing unit 13 in a predetermined manner. As such a display unit 14, for example, a display is used. Note that the display unit 14 may also have a user interface function, such as a touch display.

A processing result of the skill analysis system 10 may be transmitted to an information terminal (not illustrated) of the user via a network (not illustrated). Examples of such an information terminal include smartphones, mobile phones, tablets, personal computers, and wearable devices. In this case, the information terminal of the user functions as the display unit 14.

As illustrated in FIG. 2, the processing unit 13 includes a lower outlier exclusion unit 131, a feature extraction unit 132, a preprocessing unit 133, a correlation study unit 134, a feature selection unit 135, an analysis unit 136, and an important feature search unit 137.

The lower outlier exclusion unit 131 excludes the quality data that corresponds to a lower outlier with extremely low quality, and the measurement data associated with the quality data from an object of regression analysis by the analysis unit 136. In this way, the regression analysis is performed after excluding quality data and measurement data regarding novice workers with extremely low skills (data that may function as noise), thereby improving the precision of analysis. Note that the lower outlier will be described in detail below.

The feature extraction unit 132 extracts features from each of a plurality of types of measurement data. As such a feature, for example, a mean value or a standard deviation is used. As a specific example, a mean value of welding speeds when one worker performs welding work may be used as a feature (the same applies to other workers). A new feature may be generated based on a calculation result on the plurality of types of measurement data. For example, in arc welding, current [A]×voltage [V]×60/welding speed [cm/min] is equal to heat input [J/cm], and this heat input [J/cm] often has a significant influence on quality of the welding work (for example, quality of the work object). Therefore, the heat input [J/cm] may be used as one of the features.

The preprocessing unit 133 performs predetermined preprocessing on the feature extracted by the feature extraction unit 132. For example, the preprocessing unit 133 performs standardization (that is, preprocessing) by dividing a deviation of the feature from the average value by a standard deviation. Such standardization makes it possible to correctly evaluate the influence on the quality even when features of measurement data have different units. Note that there is no particular need to perform preprocessing such as standardization on the quality data. This is because the regression analysis described below has only one response variable (quality data).

The correlation study unit 134 studies a correlation between the features of the measurement data. To study such a correlation, a method such as calculating a correlation coefficient is used. A threshold used as a criterion for determining whether there is a strong correlation between predetermined features is not particularly limited, and for example, it may be determined that there is a strong correlation when an absolute value of the correlation coefficient is 0.7 or more. Note that as a method for studying the correlation, clustering such as spectral clustering may be used. A study result of the correlation study unit 134 is stored in the memory unit 11 as correlation data 11a. The correlation data is data in which a plurality of types of features having a strong correlation are associated with each other and grouped.

The feature selection unit 135 refers to the correlation data 11a, and selects one type of feature to be used in the regression analysis of the analysis unit 136 from each of the groups of features having a strong correlation. In the regression analysis described below, influence of a predictor variable (the plurality of types of measurement data) on the response variable (quality data) is analyzed. However, if features that are strongly correlated to each other are mixed in the predictor variable, a problem of so-called multicollinearity arises, and a result of the regression analysis often becomes unstable.

Note that a method for selecting the feature is not particularly limited, and for example, the type that has the largest correlation coefficient with the quality data (response variable) may be selected from among the plurality of types of features belonging to one group.

The analysis unit 136 performs the predetermined regression analysis using the quality data as a response variable and the plurality of types of features corresponding to the measurement data as predictor variables, and calculates variable importance for each type of measurement data. As such a regression analysis method, for example, multiple regression analysis, Lasso regression, Ridge regression, or partial least-squares method is used. When an amount of data is large, methods such as gradient boosting decision trees and neural networks may be used.

The “variable importance” calculated by the analysis unit 136 is a numerical value indicating a degree to which a predetermined predictor variable (a feature corresponding to the measurement data) contributes to the response variable (that is, the quality data). For example, when the multiple regression analysis is performed, a t-value is used as the variable importance. When the partial least-squares method is performed, VIP (variable importance for prediction) is used as the variable importance.

The important feature search unit 137 sorts the plurality of types of features in a descending order of the variable importance calculated by the analysis unit 136. In this way, it is possible to identify what type of features contributes to the quality of the work object. A search result by the important feature search unit 137 is displayed as an important feature on the display unit 14 in a predetermined manner.

Among the important features identified based on the results of the regression analysis, those to which there are other features that are strongly correlated are displayed on the display unit 14 in association with the other features. As described above, the plurality of types of features having a strong correlation are grouped and stored in the memory unit 11 as the correlation data 11a. In this way, by displaying the other features that are strongly correlated to the important features, the user can fully understand which features affect the quality of the work object when performing work such as welding.

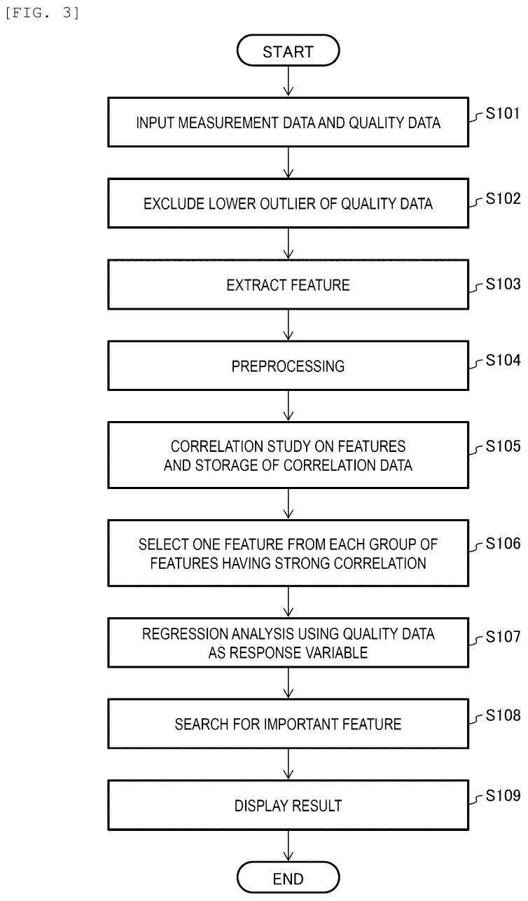

FIG. 3 is a flowchart of processing executed by the processing unit of the skill analysis system (also see FIG. 2 as appropriate).

In step S101, the processing unit 13 receives inputs of the measurement data and the quality data. As described above, the measurement data and the quality data are input via the input unit 12 from a predetermined database (not illustrated). The measurement data includes a plurality of types of data, such as an angle of the welding torch T1 (see FIG. 1) and the welding speed. The quality data includes one predetermined type of data, such as the number of defects in the work object.

In step S102, the processing unit 13 excludes the quality data corresponding to a lower outlier from the object of the regression analysis by the lower outlier exclusion unit 131. Note that the “lower” in the phrase “lower outlier” refers to low quality. That is, the processing unit 13 excludes, from the object of the regression analysis, an outlier that is on a low quality side in the quality data of the work object, and the measurement data corresponding to the quality data of the outlier (outlier excluding step).

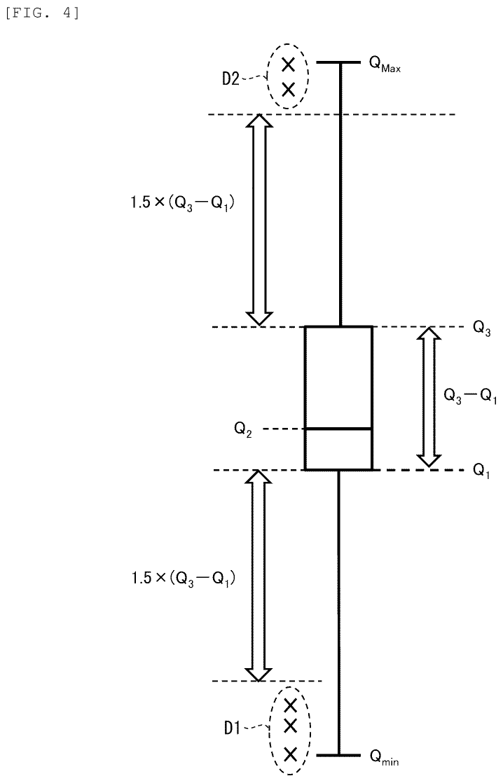

FIG. 4 is a box-and-whisker plot for excluding the quality data of the lower outlier.

Note that in the example of FIG. 4, it is assumed that the higher the quality of the work object after predetermined work is performed, the greater a value of the quality data. The box-and-whisker plot illustrated in FIG. 4 is a statistical diagram indicating a degree of dispersion of the data, and includes a minimum value Qmin, a first quartile Q₁, a median Q₂, a third quartile Q₃, and a maximum value Q_{Max}. Here, when a predetermined group of data is sorted in an ascending order in values, the first quartile Q₁ is a piece of data (that is, quality data) having a value below which 25% of the data from the smallest one falls. When a predetermined group of data is sorted in an ascending order in values, the third quartile Q₃ is a piece of data (that is, quality data) having a value below which 75% of the data from the smallest one falls. A value obtained by subtracting the first quartile Q₁ from the third quartile Q₃ (Q₃−Q₁) is called an interquartile range.

For example, when a novice performs the welding work, quality of the welding may be extremely low. In this case, when the quality is extremely low, the measurement data may act as noise during the regression analysis, resulting in a decrease in the precision of the regression analysis. Therefore, in the example of FIG. 4, the quality data whose value is smaller than a value obtained by subtracting 1.5 times the interquartile range (Q₃−Q₁) from the first quartile Q₁ (the three pieces of quality data surrounded by a dashed line D1) are excluded from the object of the regression analysis.

The measurement data corresponding to the excluded quality data is also excluded from the object of the regression analysis. In this way, the regression analysis is performed after excluding quality data of extremely low quality, thereby improving the precision of the regression analysis. In this way, when the value of the quality data becomes greater as the quality of the work object becomes higher, the processing unit 13 sets a value obtained by subtracting a product of the interquartile range (Q₃−Q₁) of the quality data and a predetermined value (for example, a value of 1.5) from the first quartile Q₁ of the quality data as a threshold, and excludes the quality data whose value is smaller than the threshold and the measurement data corresponding to the quality data from the object of the regression analysis.

For example, when the quality data is a defect rate in the work object, the lower the defect rate, the higher the quality. In this case, for example, the quality data whose value is greater than a value obtained by adding 1.5 times the interquartile range (Q₃−Q₁) to the third quartile Q₃ is excluded from the object of the regression analysis. That is, when the value of the quality data becomes smaller as the quality of the work object becomes higher, the processing unit 13 sets a value obtained by adding a product of the interquartile range (Q₃−Q₁) of the quality data and a predetermined value (for example, a value of 1.5) to the third quartile Q₃ of the quality data as a threshold, and excludes the quality data whose value is greater than the threshold and the measurement data corresponding to the quality data from the object of the regression analysis.

On the other hand, when the welding work is performed by a skilled worker with exceptionally high skills, the quality of the welding may be particularly higher than others. In this case, there is almost no possibility that the measurement data contains noise, and there is a high possibility that the measurement data contains factors that improve the quality of the welding. Therefore, in the example of FIG. 4, the quality data whose value is greater than the value obtained by adding 1.5 times the interquartile range (Q₃−Q₁) to the third quartile Q₃ (the two pieces of quality data surrounded by a dashed line D2) are included in the object of the regression analysis. That is, the processing unit 13 includes, in the object of the regression analysis, outliers on a high quality side in the quality data and the measurement data corresponding to the quality data. In this way, the measurement data and the quality data of workers with particularly high skills can be included in the object of the regression analysis.

Note that the threshold serving as the criterion for determining whether to exclude the quality data from the object of the regression analysis may be a fixed value such as 1.5×(Q₃−Q₁), but may also be user-configurable, as will be described below.

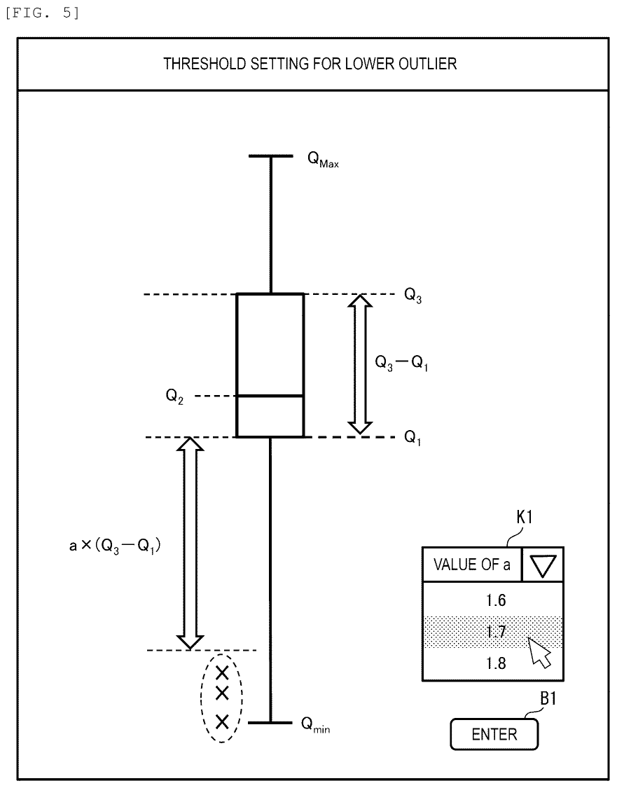

FIG. 5 is a display example regarding threshold setting for lower outliers.

In the example of FIG. 5, a box-and-whisker plot of predetermined quality data is displayed on the display unit 14 (see FIG. 2), and a pull-down list K1 for setting a threshold for the lower outliers is also displayed. Specifically, when a value obtained by subtracting a times the interquartile range (Q₃−Q₁) from the first quartile Q₁ is set as a threshold for the lower outliers, the “a times” part can be set by the user. For example, as illustrated in FIG. 5, when an enter button B1 is pressed with “1.7” selected as the value of a, the value of a is set to “1.7”.

In this way, the processing unit 13 displays the box-and-whisker plot of the quality data on the display unit 14 (display device), and further allows the predetermined value (the value of a) to be adjusted by an input operation of the user. In this way, a degree of freedom for the user in setting the threshold for lower outliers is increased. Note that the value of a set by the user may be greater than 1 or be 1 or less.

The description will be continued returning to FIG. 3.

After excluding the lower outliers of the quality data from the object of the regression analysis in step S102, the processing unit 13 proceeds to step S103. In step S103, the processing unit 13 extracts features of the measurement data by the feature extraction unit 132. That is, the processing unit 13 extracts a feature such as a mean value or a standard deviation for each of the plurality of types of measurement data. Note that a new feature, such as the heat input [J/cm] described above, may be generated by performing predetermined calculation on the plurality of types of measurement data.

In step S104, the processing unit 13 perform predetermined preprocessing by the preprocessing unit 133. For example, the processing unit 13 performs standardization as the preprocessing, such as dividing a deviation from a mean value of the measurement data by a standard deviation. After the standardization, a mean value of the data becomes 0 and a standard deviation thereof becomes 1, so that it is possible to correctly evaluate influence on the quality and the like, even of data in different units.

In step S105, the processing unit 13 generates the correlation data 11a by performing the correlation study on the features by the correlation study unit 134, and stores this correlation data 11a in the memory unit 11. That is, the processing unit 13 generates the correlation data 11a by associating and grouping the plurality of types of features having a strong correlation, and stores this correlation data 11a in the memory unit 11.

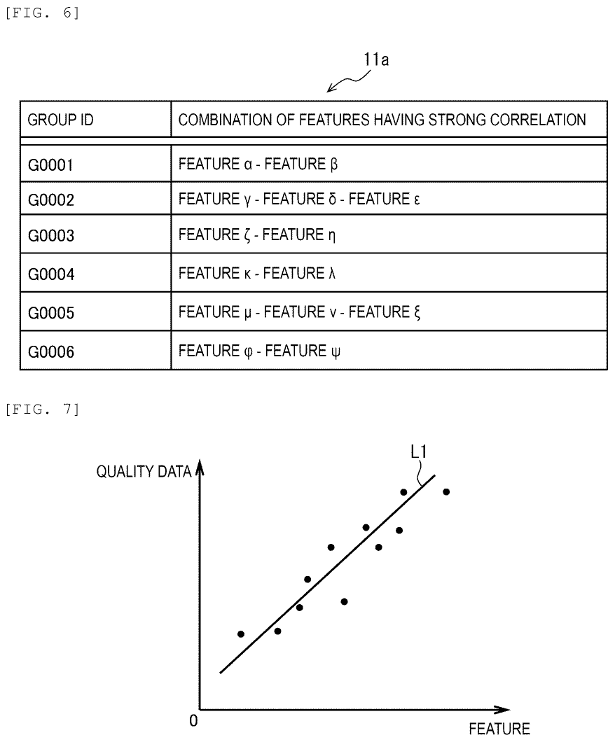

FIG. 6 is a diagram regarding the correlation data 11a.

In the example of the correlation data 11a illustrated in FIG. 6, a predetermined group ID is associated with a combination of features having a strong correlation (that is, a group). For example, in a group with a group ID of G0001, a feature α and a feature β are associated with each other as the combination of features having a strong correlation. In a group with a group ID of G0002, a feature γ, a feature δ, and a feature ε are associated with each other as the combination of features having a strong correlation. In this way, three or more types of features may be included in one group.

In step S106 in FIG. 3, the processing unit 13 selects, by the feature selection unit 135, one feature from each group of features having a strong correlation. In this way, it is possible to prevent regression analysis from being performed in a state in which features that are strongly correlated to each other are mixed. As a result, the problem of so-called multicollinearity can be prevented, and the regression analysis can be performed appropriately. For example, one feature is selected from each group in a manner such as that the feature α is selected from the group G0001 illustrated in FIG. 6, the feature γ is selected from the group G0002, and a feature ζ is selected from a group G0003.

In this way, the processing unit 13 performs the predetermined correlation study on the plurality of types of features (S105 in FIG. 3), selects one type of feature from each group indicating a combination of types of features having a relatively strong correlation, and includes the selected feature in the object of the regression analysis (S106).

Note that when there is no other type of feature that is strongly correlated to a predetermined feature, this feature will exist alone without forming any particular group. The one feature selected from each group having a strong correlation and the feature that does not form any particular group are data having a weak correlation (that is, independent variables) and are therefore suitable for the regression analysis.

Next, in step S107 in FIG. 3, the processing unit 13 performs the regression analysis using the quality data as the response variable by the analysis unit 136. Note that the predictor variables used in the regression analysis are the features selected in step S106 and the feature that does not form any particular group. By performing the regression analysis in this way, it is possible to identify which of the plurality of types of features has particular influence on the quality of the work object. The regression analysis also calculates the variable importance indicating the degree to which each predictor variable (that is, the feature based on the measurement data) contributes to the response variable (that is, the quality data).

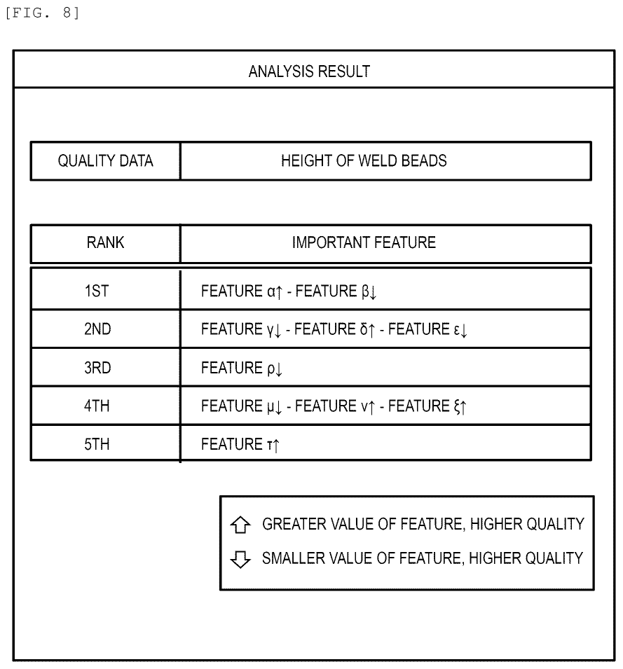

FIG. 7 is a diagram regarding multiple regression analysis, which is an example of the regression analysis.

Note that a vertical axis of FIG. 7 represents the feature based on the predetermined measurement data, and a horizontal axis represents the quality data. For simplicity, FIG. 7 shows one feature, but in reality, the multiple regression analysis is performed based on a plurality of types of features. A plurality of points plotted in FIG. 7 represent data corresponding to a plurality of workers. A straight line L1 is a straight line expressed by a predetermined regression equation based on a least-squares method or the like. As a result of the multiple regression analysis, a t-value corresponding to the variable importance is calculated. The t value is a numerical value indicating the degree of influence that the feature has on the quality data, and is calculated for each of the plurality of types of features. Note that the regression analysis method is not limited to the multiple regression analysis, and as described above, other methods such as the Lasso regression, Ridge regression, and partial least-squares method may be used.

After performing the regression analysis in this way, in step S108 in FIG. 3, the processing unit 13 searches for an important feature by the important feature search unit 137. That is, the processing unit 13 sorts the features in a descending order of the variable importance of each feature calculated as a result of the regression analysis. For example, the important feature sorted first has the highest variable importance and therefore can be said to contribute most to the quality of the work object.

Next, in step S109 of FIG. 3, the processing unit 13 causes the display unit 14 to display an analysis result. In this way, the processing unit 13 performs the regression analysis using the features of the measurement data regarding the work performed by the worker on the work object as the predictor variables and using the quality data of the work object as the response variable (S108), and causes the display unit 14 (display device) to display the extraction result of the important feature based on the regression analysis (displaying step).

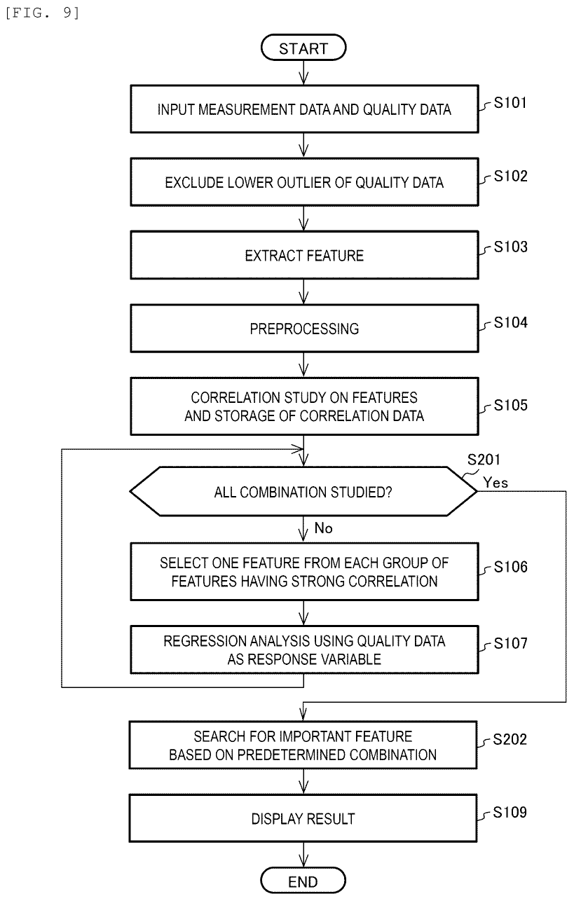

FIG. 8 is a display example of the analysis result.

In the example of FIG. 8, an analysis result in a case where a height of weld beads is used as the quality data is displayed. Specifically, when the features are sorted, the first to fifth important features are displayed side by side in a vertical direction on the display unit 14 (see FIG. 2). In the example of FIG. 8, the feature α and the feature β are listed as important features that have the greatest influence on the height of the weld beads (quality data). Here, it is assumed that the feature α and the feature β belong to one group having a strong correlation and are read out from the correlation data 11a (see FIG. 2).

As described above, one feature is selected from each group of features having a strong correlation and then the regression analysis is performed (S106 and S107 in FIG. 3). Therefore, the important feature identified based on the variable importance is one of the feature α and the feature β (for example, the feature α). The processing unit 13 refers to the correlation data 11a stored in the memory unit 11, and if there is another feature (for example, feature β) that is associated with the important feature, displays the other feature as well.

When the processing unit 13 causes the display unit 14 (display device) to display the important feature extracted by the regression analysis, and the important feature belongs to a predetermined group, the processing unit 13 displays the other feature belonging to the group in association with the important feature. In this way, the user can easily understand that both the feature α and the feature β, which have a strong correlation, affect the height of the weld beads.

An upward arrow next to the feature α in FIG. 8 indicates that the quality of the work object becomes higher as a value of the feature α becomes greater. A downward arrow next to the feature β indicates that the quality of the work object becomes higher as a value of the feature becomes smaller. By showing these arrows, the user can understand at a glance whether the quality becomes higher as the value of the feature based on the measurement data becomes greater or smaller.

In the example of FIG. 8, a feature γ, a feature δ, and a feature ε are shown as the second important features. One of the feature γ, the feature δ, and the feature ε is identified by the regression analysis, and the rest are read out from the correlation data 11a (see FIG. 2).

A feature ρ is shown as the third important feature. This feature ρ is not included in the correlation data 11a (see FIG. 2) since there are no other features to which the feature ρ is strongly correlated.

### Effects

According to the first embodiment, the quality data of the lower outliers of work objects with extremely low quality, and the measurement data corresponding to the quality data are excluded from the object of the regression analysis (S102 in FIG. 3). In this way, data that acts as noise is excluded, thereby improving the precision of analysis when performing the regression analysis.

When the processing unit 13 displays the important feature identified by the regression analysis, other features that have a strong correlation to this important feature are also displayed. In this way, the user can fully understand which features (measurement data) have strong influence on the quality of the work object.

According to the first embodiment, by presenting to the user the important features that are likely to affect the quality of the work object, it is possible to support work of expressing tacit knowledge (unverbalized knowledge) of a skilled worker as explicit knowledge (verbalized knowledge). In other words, by automating the extraction of important features, at least a part of work of turning tacit knowledge of a skilled worker into explicit knowledge can be made non-personal and completed in a short period of time. Furthermore, the result of the regression analysis can be used for predetermined skill training, quality control, assistance of work operations, and the like.

### Second Embodiment

The second embodiment differs from the first embodiment in that the processing unit 13 (see FIG. 2) performs regression analysis for each of all combinations when selecting one feature from each group of features having a strong correlation. Note that other aspects (such as the configuration of the skill analysis system 10: see FIG. 2) are similar to those of the first embodiment. Therefore, parts different from those of the first embodiment will be described, and description of repeated parts will be omitted.

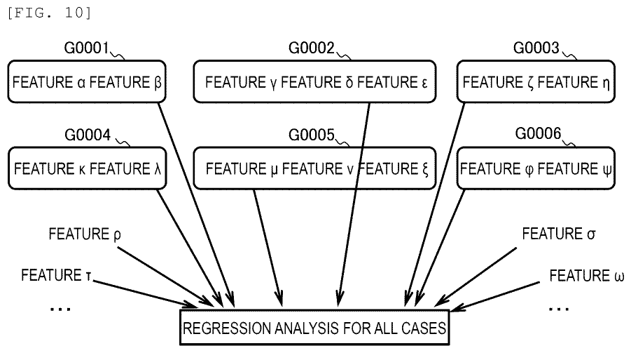

FIG. 9 is a flowchart of processing executed by a processing unit of a skill analysis system according to the second embodiment (also see FIG. 2 as appropriate).

Note that steps S101 to S105 in FIG. 9 are the same as those in the first embodiment (see FIG. 3), and therefore description thereof will be omitted. After studying the correlation between the features and storing the correlation data 11a in step S105 in FIG. 9, the processing unit 13 proceeds to step S201.

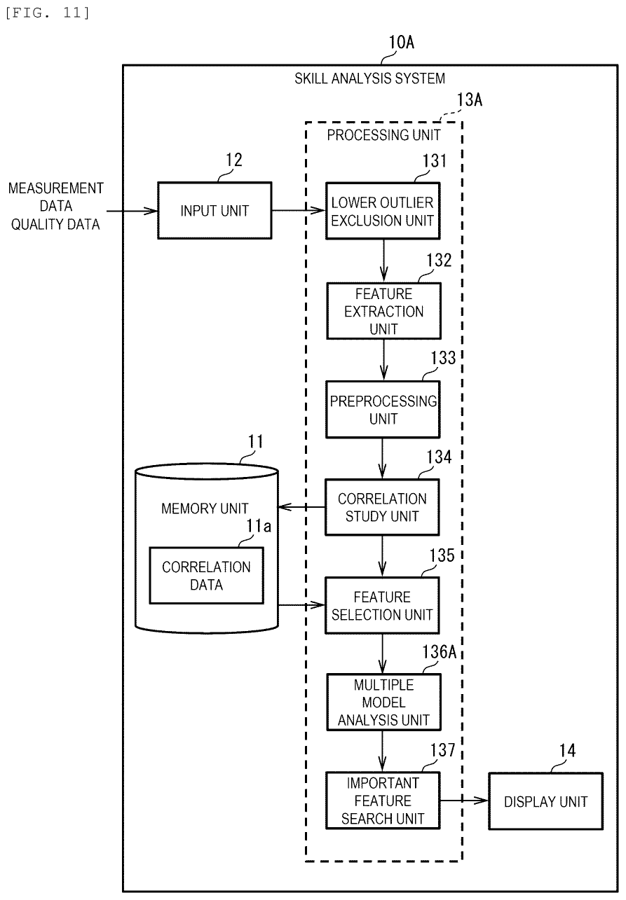

In step S201, the processing unit 13 determines whether all combinations have been studied. That is, the processing unit 13 determines whether all combinations when selecting one from each group of features having a strong correlation have been studied. In step S201, if there is a combination of features that has not yet been studied (that is, a combination of features for which regression analysis has not been performed) (S201: No), the processing unit 13 proceeds to step S106. Here, a method for selecting a feature will be described with reference to FIG. 10.

FIG. 10 is a diagram regarding selection of a feature as the object of the regression analysis.

Note that in FIG. 10, a total of six groups with group IDs “G0001” to “G0006” correspond to the correlation data 11a illustrated in FIG. 6. For example, when selecting one feature from each of the six groups illustrated in FIG. 10, there are 2⁴×3²=144 combinations. The processing unit 13 refers to the correlation data 11a (see FIG. 2) in the memory unit 11, selects one feature from each of the six groups, and performs the regression analysis by further including features ρ, τ, σ, ω, . . . that do not form any group in the predictor variables (S107: see FIG. 9). Then, the processing unit 13 performs the regression analysis on all combinations when selecting one feature from each of the six groups.

The description will be continued returning to FIG. 9.

In step S106, the processing unit 13 selects one feature from each group of features having a strong correlation. Note that the combination of features selected in step S106 is a combination for which regression analysis has not yet been performed.

In step S107, the processing unit 13 performs the regression analysis using the quality data as the response variable by the analysis unit 136. In other words, the processing unit 13 performs the regression analysis using the features of the combination selected in step S106 as well as features not included in the correlation data 11a (features to which there are no other features are strongly correlated) as the predictor variables and using the quality data as the response variable. After performing the processing of step S107, the processing unit 13 returns to step S201.

In step S201, if all the combinations of features have been studied (S201: Yes), the processing unit 13 proceeds to step S202. In step S202, the processing unit 13 searches for an important feature based on a predetermined combination of features. That is, the processing unit 13 identifies, from among the combinations when selecting one type of feature from each of a plurality of groups, a combination in which the correlation coefficient between the estimated value of the response variable (quality data) based on the combination and an actual value of the response variable (quality data) is closest to 1. Then, the processing unit 13 sorts the features in a descending order of variable importance based on the result of the regression analysis for the combination with the correlation coefficient closest to 1, and identifies, for example, the features sorted to be the first to fifth as the important features.

In step S109, the processing unit 13 causes the display unit 14 to display the analysis result. Note that the display example of the analysis result is the same as that of the first embodiment (see FIG. 8), and therefore description thereof will be omitted.

### Effects

According to the second embodiment, the processing unit 13 performs comprehensive regression analysis on all combinations when selecting one feature from each group. In this way, it is possible to identify with high precision, among the plurality of types of features based on the measurement data, those features that affect the quality of the work object.

### Third Embodiment

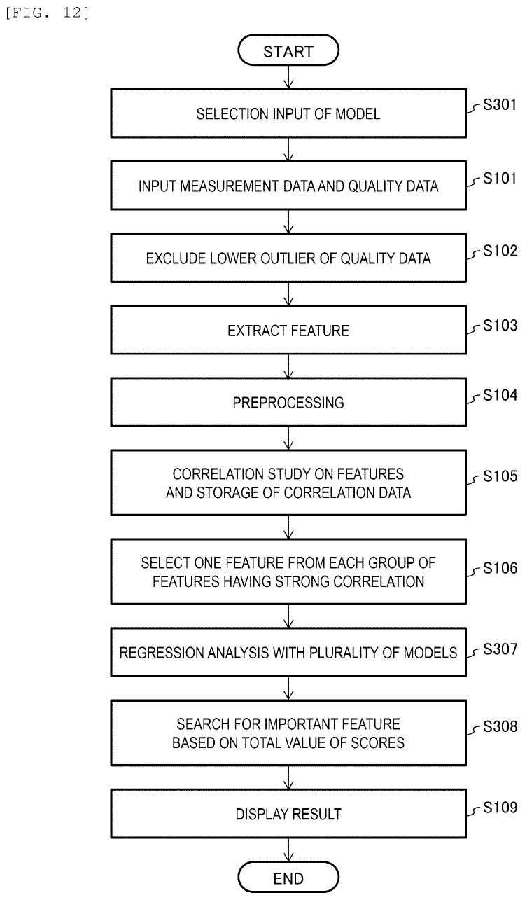

The third embodiment differs from the first embodiment in that a processing unit 13A (see FIG. 11) performs regression analysis using each of a plurality of types of models, and searches for the important features further based on a total value of scores based on variable importance. Note that other configurations are the same as those in the first embodiment. Therefore, parts different from those of the first embodiment will be described, and description of repeated parts will be omitted.

FIG. 11 is a functional block diagram of a skill analysis system 10A according to the third embodiment.

The processing unit 13A of the skill analysis system 10A illustrated in FIG. 11 has a configuration including a multiple model analysis unit 136A instead of the analysis unit 136 (see FIG. 2) included in the configuration described in the first embodiment. The multiple model analysis unit 136A performs regression analysis based on each of a plurality of models using different analysis methods. As such a plurality of models, for example, the multiple regression analysis, Lasso regression, partial least-squares method, and Ridge regression are used. Note that when an amount of data is large, methods such as gradient boosting decision trees and neural networks may be used.

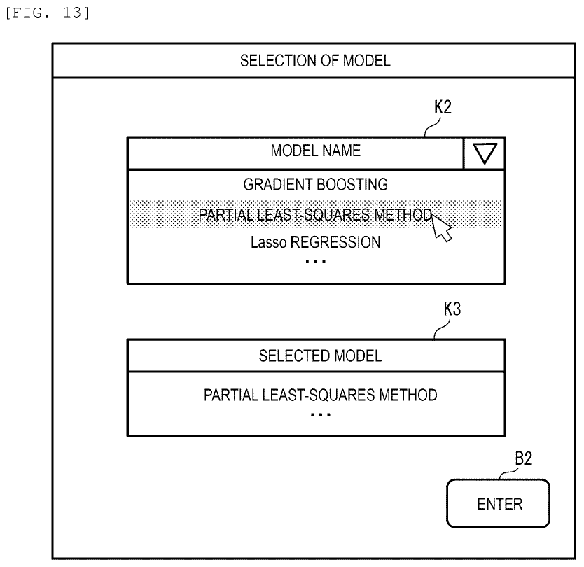

FIG. 12 is a flowchart of processing executed by the processing unit of the skill analysis system (see FIG. 11 as appropriate).

Note that steps S101 to S106 in FIG. 12 are the same as those in the first embodiment (see FIG. 3), and therefore description thereof will be omitted. After selecting one feature from each group of features having a strong correlation in step S106, the processing unit 13A proceeds to step S307.

In step S307, the processing unit 13A performs the regression analysis using each of the plurality of models by the multiple model analysis unit 136A. For example, the processing unit 13A performs the regression analysis using each of three methods of the gradient boosting decision tree, the partial least-squares method, and the Lasso regression. Note that the plurality of models used in step S307 may be preset, or may be selectable by the user, as will be described below.

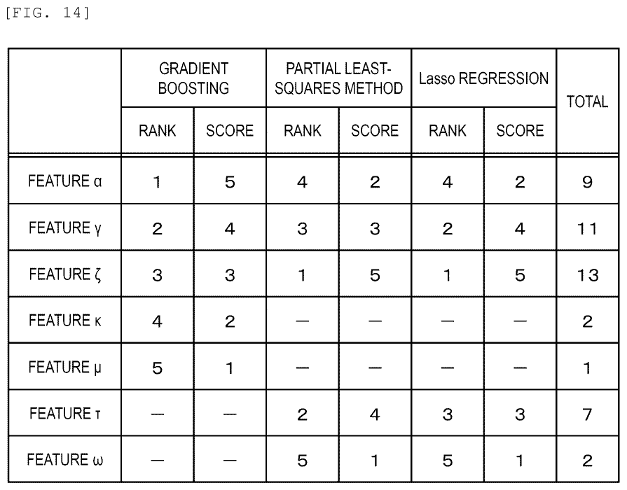

FIG. 13 is a display example of a selection screen for the model used in the regression analysis.

As illustrated in FIG. 13, a predetermined model regarding the regression analysis may be selected from a pull-down list K2 based on an input operation of the user. In the example of FIG. 13, the partial least-squares method is selected from among model candidates used in the regression analysis. A name of the model selected by the user is displayed in a presentation column K3 below the pull-down list K2. That is, the processing unit 13A (see FIG. 11) causes the display unit 14 (display device) to display the selection screen when the user selects, through input operation, a plurality of types of models to be used for extracting the important features from among the model candidates for the regression analysis.

After selecting a plurality of types of models, the user presses an enter button B2. In this way, by allowing the user to select, from among model candidates for the regression analysis, a plurality of types of models to be actually used, a degree of freedom of setting by the user is increased.

Next, in step S308 in FIG. 12, the processing unit 13A searches for the important feature based on a total value of scores by the important feature search unit 137. For example, the processing unit 13A sorts the features in a descending order of the variable importance based on a result when a predetermined regression analysis model is used, and further assigns scores to the features according to the sorting. The processing unit 13A also performs the same processing when regression analysis is performed using other models. Then, the processing unit 13A calculates a total value of the scores corresponding to the plurality of types of models for each feature, and extracts a predetermined number of features in a descending order of the total value as the important features.

FIG. 14 is a diagram regarding the extraction of the important features when a plurality of types of models are used.

In the example of FIG. 14, for example, when the gradient boosting decision tree is used as the regression analysis method, the features α, γ, ζ, κ, and μ are sorted as the first to fifth in a decreasing order of the variable importance. The feature with the highest variable importance is assigned with a score of 5, the feature with the second highest variable importance is assigned with a score of 4, the feature with the third highest variable importance is assigned with a score of 3, the feature with the fourth highest variable importance is assigned with a score of 2, and the feature with the fifth highest variable importance is assigned with a score of 1. Note that the same applies to a case where the partial least-squares method or the Lasso regression is performed.

Then, the processing unit 13A calculates a total score for each of the features α, γ, ζ, κ, ρ, τ, and ω when each regression analysis method is performed. In the example of FIG. 14, the feature ζ has the highest total score, followed by the features γ, α, τ, κ, ω, and μ (however, the features κ and ω have the same total score). In this way, the processing unit 13 performs the regression analysis with each of the plurality of types of models, and assigns a score to the feature for each model based on the variable importance, which indicates the degree to which the predictor variable (measurement data) contributes to the response variable (quality data). Then, the processing unit 13 extracts an important feature based on a total value of the scores. Note that a scoring method and a sorting method for the features illustrated in FIG. 14 are merely examples and the invention is not limited thereto.

After searching for the important feature in this way, the processing unit 13A displays the analysis result in step S109 of FIG. 12. Note that the display example of the analysis result is the same as that of the first embodiment (see FIG. 8), and therefore description thereof will be omitted.

### Effects

According to the third embodiment, the processing unit 13A uses a plurality of models as methods for the regression analysis. Each of the methods (that is, the plurality of models) for the regression analysis has advantages and disadvantages, being superior to other methods in some respects and inferior in others, but by comparing the total scores based on the plurality of models, it is possible to obtain an analysis result that is highly versatile (that is, robust) with high precision.

### Modification

The skill analysis systems 10, 10A and the skill analysis methods according to the present disclosure have been described in each embodiment above, but the present disclosure is not limited to these descriptions and various modifications can be made.

For example, in each embodiment, the case has been described in which one type of quality data is used in the regression analysis, but a plurality of types of quality data may be used. In this case, the series of processing illustrated in FIG. 3 and the like is performed for each type of quality data.

In the flowchart illustrated in FIG. 3, the order of the processing of steps S102 and S103 may be interchanged. That is, the processing unit 13 may extract the feature based on the measurement data, and then exclude the lower outliers of the quality data. Note that the same applies to the second and third embodiments.

Furthermore, the processing (skill analysis method) performed by the skill analysis systems 10, 10A may be executed as a specified program on a computer. The above-mentioned program can be provided via a communication line, or can be written onto a recording medium such as a CD-ROM and distributed.

The present disclosure is not limited to each embodiment and includes various modifications. For example, each of the embodiments is described in detail to describe the present disclosure in an easy-to-understand manner and is not necessarily limited to including all the described configurations. A part of a configuration according to a certain embodiment can be replaced with a configuration according to another embodiment, and a configuration according to another embodiment can be added to a configuration according to a certain embodiment. In addition, another configuration can be added to a part of a configuration of each embodiment, and the part of the configuration of each embodiment can be deleted or replaced with another configuration.

A part all of the configurations, functions, processing units, processing methods, and the like described above may be implemented by hardware by, for example, designing with an integrated circuit. The above configurations, functions, and the like may be implemented by software by a processor interpreting and executing a program for implementing each function. Information such as a program, a table, and a file for implementing each function can be stored in a storage device such as a memory, a hard disk, and a solid state drive (SSD), or in a recording medium such as an IC card, an SD card, and a DVD.

Control lines and information lines indicate what is considered to be necessary for description, and not necessarily all control lines and information lines are always shown on a product. Actually, it may be considered that almost all the configurations are connected to one another.

### REFERENCE SIGNS LIST

10, 10A: skill analysis system
11: memory unit
11a: correlation data
12: input unit
13, 13A: processing unit
14: display unit (display device)
131: lower outlier exclusion unit
132: feature extraction unit
133: preprocessing unit
134: correlation study unit
135: feature selection unit
136: analysis unit
136A: multiple model analysis unit
137: important feature search unit
M1: worker
W1: work object
S102: step (outlier excluding step)
S109: step (displaying step)

1. A skill analysis system comprising:
a processing unit that performs regression analysis using a feature of measurement data regarding work performed by a worker on a work object as a predictor variable and using quality data of the work object as a response variable, and causes a display device to display an extraction result of an important feature based on the regression analysis, wherein
the processing unit excludes, from an object of the regression analysis, an outlier that is on a low quality side in the quality data and the measurement data that corresponds to the quality data of the outlier.

2. The skill analysis system according to claim 1, wherein
the processing unit includes, in the object of the regression analysis, an outlier on a high quality side in the quality data and the measurement data that corresponds to the quality data.

3. The skill analysis system according to claim 1, wherein
the processing unit performs predetermined correlation study on a plurality of types of features, selects one type of feature from each group indicating a combination of types of features having a relatively strong correlation, and includes the selected feature in the object of the regression analysis.

4. The skill analysis system according to claim 3, wherein
when the processing unit causes the display device to display the important feature extracted by the regression analysis and the important feature belongs to a predetermined group, the processing unit causes the display device to display another feature belonging to the group in association with the important feature.

5. The skill analysis system according to claim 1, wherein
when a value of the quality data becomes greater as quality of the work object becomes higher, the processing unit sets a value obtained by subtracting a product of an interquartile range of the quality data and a predetermined value from a first quartile of the quality data as a threshold, and excludes the quality data whose value is smaller than the threshold and the measurement data corresponding to the quality data from the object of the regression analysis.

6. The skill analysis system according to claim 1, wherein
when a value of the quality data becomes smaller as quality of the work object becomes higher, the processing unit sets a value obtained by adding a product of an interquartile range of the quality data and a predetermined value to a third quartile of the quality data as a threshold, and excludes the quality data whose value is greater than the threshold and the measurement data corresponding to the quality data from the object of the regression analysis.

7. The skill analysis system according to claim 5, wherein
the processing unit causes the display device to display a box-and-whisker plot of the quality data, and further allows a user to adjust the predetermined value by input operation.

8. The skill analysis system according to claim 3, wherein
the processing unit identifies, from among combinations when selecting one type of feature from each of the plurality of groups, a combination in which a correlation coefficient between an estimated value of the response variable based on the combination and an actual value of the response variable is closest to 1, and performs the regression analysis based on the feature including the combination.

9. The skill analysis system according to claim 1, wherein
the processing unit performs the regression analysis with each of a plurality of types of models, assigns a score to the feature for each of the models based on variable importance indicating a degree to which the predictor variable contributes to the response variable, and extracts the important feature based on a total value of the scores.

10. The skill analysis system according to claim 9, wherein
the processing unit causes the display device to display a selection screen for selecting, by input operation of a user, from among model candidates of the regression analysis, a plurality of types of models used for extracting the important feature.

11. A skill analysis method comprising:
an outlier excluding step of excluding, from an object of regression analysis, an outlier that is on a low quality side in quality data of a work object and measurement data regarding work performed by a worker on the work object and corresponding to the quality data of the outlier; and
a displaying step of performing the regression analysis using a feature of the measurement data as a predictor variable and using the quality data as a response variable, and causing a display device to display an extraction result of an important feature based on the regression analysis.

12. The skill analysis system according to claim 6, wherein
the processing unit causes the display device to display a box-and-whisker plot of the quality data, and further allows a user to adjust the predetermined value by input operation.
